(19) United States
(12) Patent Application Publication
(10) Pub. No.: US 2007/0095221 A1
(43) Pub. Date: May 3, 2007

(54) Substrate having frangible stencil segments

(76) Inventor: Stephanie Rene Lee, Phoenix, AZ (US)

Correspondence Address: LEWIS AND ROCA LLP, 40 NORTH CENTRAL AVENUE, PHOENIX, AZ, 85004, US

(21) Appl. No.: 11/266,859

(22) Filed: Nov. 3, 2005

(51) Int. Cl. B41N 1/24; B65H 35/06

(52) U.S. Cl. 101/127

(57) ABSTRACT

A substrate includes a plurality of segments each having one or more stencils. A frangible portion of the substrate is located between adjacent segments. Alternatively, a stencil dispensing apparatus includes a substrate roll having a plurality of the segments. Indicia can be on the substrate roll and equidistant from the nearest stencil on adjacent segments of the substrate. The substrate roll can be in a container having means for separating adjacent segments of the substrate at the indicia there between. A stencil dispenser is also disclosed and includes the substrate rolled into a hollow tube having a spindle therein to pay out and take up the segments, where a means for separating adjacent segments of the substrate at the indicia there between is also provided with the stencil dispenser.

### FIELD OF INVENTION

This invention relates to stenciling, and more particularly relates to a substrate having frangible stencil segments.

### BACKGROUND

Stencils are used to apply decorative patterns, icons and symbols. Stencils are general provided by cutting out patterns, icons and/or symbols from a substrate. The substrate can be made of paper, plastic, their combination, etc. Application of a stencil can be by filling in, or by outlining the periphery, of the stencil with a color. The color can be applied using a pencil or other writing instrument, a paint brush, a spray can of paint, etc.

In order to provide a desired irregular spacing between stencils being applied to a surface, a person using the substrate must precisely manipulate the substrate to ensure that each stencil being applied has the desired irregular spacing from adjacent substrates. Alternatively, the person can use a cutting instrument (e.g.; knife, scissors, razor blade) to sever the substrate between adjacent stencils prior to their application to the surface. In the latter case, the person using the cutting instrument must still precisely manipulate the cutting instrument to ensure that each stencil is severed from the substrate without deforming the shape of the stencil or that of adjacent stencils. It would be an advance in the art to provide a way to separate adjacent stencils from a substrate in such as way so as to be easily applied in an irregular, yet desirable spacing.

It may be desirable to apply a pattern, icon, or symbol using stencils in a first direction, and then to alter the application in a different direction. This can present a problem in maintaining an esthetic application of the stencils with respect to providing a desired spacing. In particular, a change in direction for the application of the stencils requires that the substrate be precisely manipulated from the first direction to a second, different direction while maintaining the desired spacing between adjacent stencils. In would be an advance in the art to provide an easy way to change the direction of applying stencils while maintaining a desirable spacing between adjacent stencils.

### SUMMARY

In one implementation, a substrate includes a plurality of segments each having one or more stencils. A frangible portion of the substrate is located between adjacent segments.

In another implementation, a stencil dispensing apparatus is provided. The apparatus includes a substrate roll having a plurality of segments. Each segment has one or more stencils. Indicia is on the substrate and equidistant from the nearest stencil on adjacent segments of the substrate. A container for the substrate roll is including in the apparatus as is a means for separating adjacent segments of the substrate at the indicia there between.

In yet another implementation, a stencil dispenser is provided. The stencil dispenser includes a substrate having a plurality of segments. Each segment has one or more stencils and the substrate is rolled into a hollow tube. Indicia is on the substrate equidistant from the nearest stencil on adjacent segments of the substrate. A spindle is within the hollow tube and against the substrate. The spindle can be used to pay out and take up the segments of the substrate. A means for separating adjacent segments of the substrate at the indicia there between is also provided with the stencil dispenser.

### BRIEF DESCRIPTION OF THE DRAWINGS

A more complete understanding of the implementations may be had by reference to the following detailed description when taken in conjunction with the accompanying drawings wherein:

FIG. 1 shows a perspective view of an exemplary implementation of a substrate including a plurality of segments each having one or more stencils, where there is an indicia and/or a frangible portion of the substrate is located between adjacent segments, and where the substrate is rolled up;

FIG. 2 depicts an exemplary implementation of a stencil dispensing apparatus containing a substrate roll having a plurality of segments each of which has one or more stencils, where indicia is on the substrate and equidistant from the nearest stencil on adjacent segments of the substrate, and where a serrated edge is on the apparatus for separating adjacent segments of the substrate at the indicia there between;

FIG. 3 an exemplary implementation of a stencil dispenser that includes a substrate having a plurality of segments each having one or more stencils, where the substrate is rolled into a hollow tube having a spindle within the hollow tube and against the substrate, where indicia is on the substrate equidistant from the nearest stencil on adjacent segments of the substrate, and where a means for separating adjacent segments of the substrate at the indicia there between is also provided with the stencil dispenser;

FIGS. 4 and 5 respectively show perspective views of substrate segments normal one to the other, before and during the perpendicular application of stencils to a surface;

FIG. 6 show the application of stencils to a ruled note pad via spray paint, where the stencils being applied are on a segment of a substrate, where the stencils can be a set of related symbols; and

FIGS. 7-14 show stencils on respective segments of a substrate being applied to non-planar surfaces in linear and non-linear directions.

### DETAILED DESCRIPTION

A substrate can be provided so as to have a plurality of segments. Each segment can have at least one stencil. A frangible portion of the substrate is provided between adjacent segments, where each frangible portion of the substrate is more easily broken than each segment. The plurality of segments are flexible so that the substrate can be rolled into a hollow tube.

In one implementation, one or more of the segments each have a set of stencils, where each set have topically related stencils (e.g.; the stencil shapes are topically related). For instance, a set can be all of the letters in an alphabet, related symbols of a written language, declinations of a noun, conjugations of a verb, shapes characterizing male and female of a species, shapes characterizing progressively different ages of a species, all of the single digit numbers, related chemical symbols, relate mathematical symbols, etc.

The frangible portion of the substrate will preferably be a perforation in the substrate, although other ways of making the substrate more susceptible to breaking, tearing, or being severed at one location than at others are also contemplated. For instance, the substrate can be thinner between adjacent segments than elsewhere, the substrate can be weakened by a mechanical or chemical process between adjacent segments than elsewhere, etc. The frangible portion makes adjacent segments of the substrate easier to separate at precise locations. The frangible portion of the substrate will preferably be about equidistant from the nearest stencil on adjacent segments of the substrate.

In another implementation, the frangible portion of the substrate can include a means for detaching and reattaching adjacent segments of the substrate. For instance, this means can be a zipper, one or more sets of a hook and an eye, one or more sets of a button and button hole; hook and loop fabric fasteners (e.g.; Velcro® material or different brand thereof), a sticky material on at least one of the adjacent segments, etc. Preferably the detaching and reattaching means will allow for the detaching of adjacent segments of the substrates that are at a first orientation one to the other followed by a reattaching one to the other at a second, different orientation. For instance, the first orientation can be linear (e.g., one hundred-eighty degrees), and the second orientation can normal to the first orientation (e.g., ninety degrees), the first orientation of adjacent segments can form an acute angle while the second orientation of the adjacent segments can form a non-acute angle.

In yet another implementation, each stencil can be filled with a punch out portion, where the punch out portion is held within the stencil by one or more frangible materials. As such, each punch out portion can be removed from within the stencil by pressure on the same without substantially deforming the stencil. The punch out portion can have a sticky substance on one surface thereof, and the sticky substance can be revealed by removal of a covering.

In a still further implementation, a stencil dispensing apparatus is provided. The apparatus has a container for a substrate roll and the substrate roll has a plurality of segments each having one or more stencils. There are indicia on the substrate equidistant from the nearest stencil on adjacent segments of the substrate, and there is a means for separating adjacent segments of the substrate at the indicia there between. The indicia on the substrate can either be or can include a frangible portion of the substrate, and the frangible portion of the substrate can be a perforation in the substrate. The separating means can be a serrated edge upon which the indicia is pressured to separate the adjacent segments.

In yet another implementation, a stencil dispenser is provided. The stencil dispenser has substrate having a plurality of segments each having one or more stencils. The substrate is rolled into a hollow tube. Spindle is situated within the hollow tube and against the substrate. The spindle can be used for paying out and for taking up the segments of the substrate. Indicia is on the substrate equidistant from the nearest stencil on adjacent segments of the substrate. Means is provided for separating adjacent segments of the substrate at the indicia there between. The indicia on the substrate can either be or can include a frangible portion of the substrate, and the frangible portion of the substrate can be a perforation in the substrate. The separating means can be a serrated edge upon which the indicia is pressured to separate the adjacent segments.

As mentioned, the frangible portion of the substrate can be a perforation in the substrate. The perforation is advantageous in that one segment of the substrate can be torn off at a precise position—namely at the perforation. Also, one or more segments can be torn off at a perforation from the substrate roll at a time. Once the perforation is broken, the stencils can be applied in horizontal, vertical, and/or multiple of directions. The perforation prevents the stencils for being torn by limiting the tearing of the substrate at the location of the perforation. Moreover, perforations can be made in the substrate so that each stencil is lined up and precise in the same distance apart from one another. Thus, the perforations provide uniformity to the length of the segments in the substrate. The perforations can demark the start of one stencil shape, the changing to a different stencil shape, or to start a repetition of the same stencil shape.

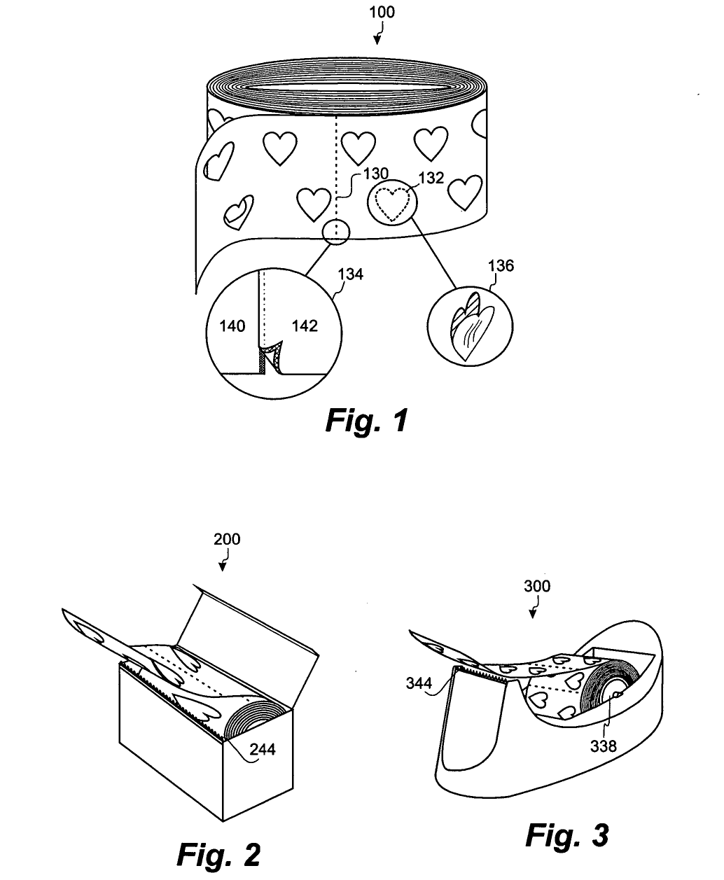

FIG. 1 shows a substrate roll 100 in a perspective view. Substrate roll 100 has indicia 130 thereon. Indicia 130 can be a making on the substrate roll, a perforation, or a weakening or other frangible portion of substrate roll 100. Substrate roll 100 can be deemed to be divided into respective segments at each of a plurality of indicia 130. Indicia 130 can be used to break off substrate roll 100 at specific lengths, or specific segments having a set of stencils therein. As seen in FIG. 1, a plurality of stencils are situated within each segment as divided by indicia 130. Indicia 130 can be a perforation that is indented into substrate roll 100 by a mechanical means. Alternatively, indicia 130 can be merely printed indicia on substrate roll 100. As a further alternative, indicia 130 can be a mechanical or chemical wearing or weakening of substrate roll 100 so as to make each such indicia 130 frangible with respect to other portions of substrate roll 100. As such, substrate roll 100 can be precisely divided at the indicia 130.

Indicia 130 is in exploded view seen at referenced numeral 134. Reference 134 shows an alternative implementation in which first and second segments, respectively 140, 142, can be detached and reattached using a variety of attachment means. By way of example, the attachment and detaching means can be a zipper, button with buttonhole, hook and eye, hook and loop fabric fastening (e.g., Velcro® or similar fabric attaching device), tongue and groove, etc.).

At reference numeral 136 of FIG. 1, a punch-out is seen as being in the process of being punched out from within a stencil in substrate roll 100. Also seen in reference numeral 136 is a covering for a sticky substance that is upon the punch-out 136. When punch-out 136 has been removed from the stencil, the punch out can be sticky to another surface by the sticky substance, while the stencil 132 still remains as seen in FIG. 1.

FIG. 2 shows a container for a substrate roll, such as substrate roll 100, as seen at reference numeral 200. A serrated edge 244 is upon the container so that substrate roll 100 can be separated into respective segments at indicia 130 upon substrate roll 100.

FIG. 3 shows a stencil dispenser 300 having substrate roll 100 situated upon a spindle 338 or paying out and taking up substrate roll 100. Spindle 338 is within a hollow tube formed by substrate roll 100 and up against the inside of the hollow tube. A serrated edge 344 is upon stencil dispenser 300 so that substrate roll 100 can be divided into respective segments at each indicia 130 seen on substrate roll 100. In that way, both the stencil dispenser 300 and the substrate roll container 200 can be used to precisely divide substrate roll 100 into lengths of respective segments at indicia 130.

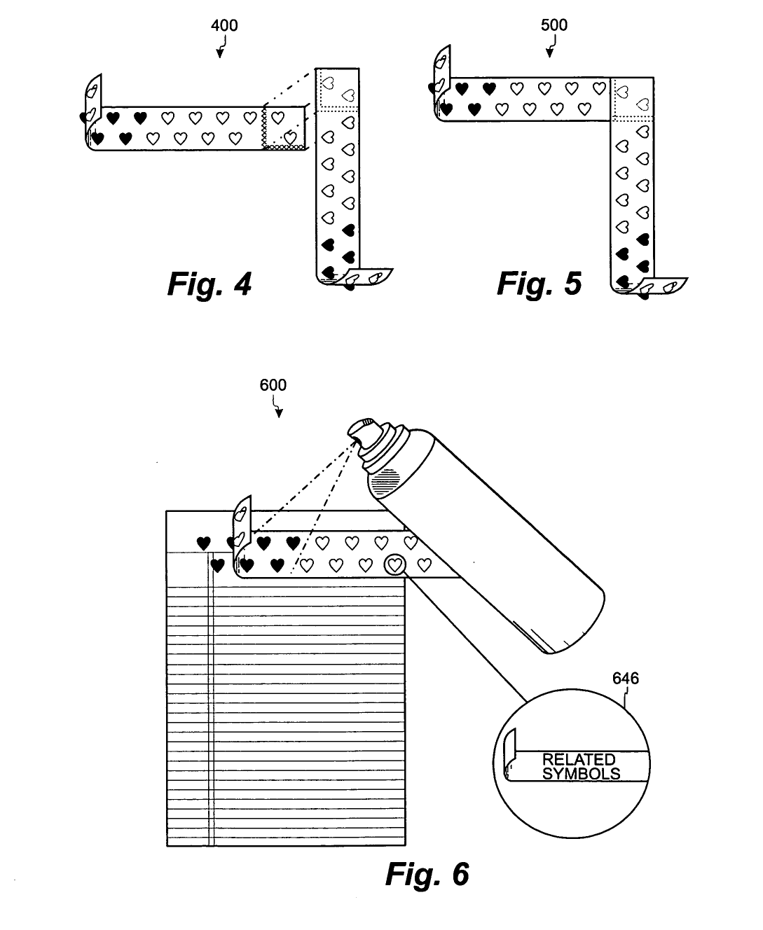

FIG. 4 shows a perspective view of respective segments of substrate roll 100 that have been detached, and oriented at a ninety degree angles.

FIG. 5 shows the placement of one segment upon another segment at reference numeral 500 via use of a reattachments means (e.g., loop and hook fabric). As such, stencil segments can be detached and then reattached at different angles in order to do stenciling in changing directions.

FIG. 6 shows at reference numeral 600 a spray can being used to apply stencils upon a segment of substrate roll 100 to a ruled notepad. Reference numeral 646 shows that various related symbols can be in one segment of substrate roll 100. By way of example, the related symbols 646 can be letters of the alphabet, single digit numbers, declined nouns, conjugated verbs, respective ages of a species of mammal, male and female of a species, etc.

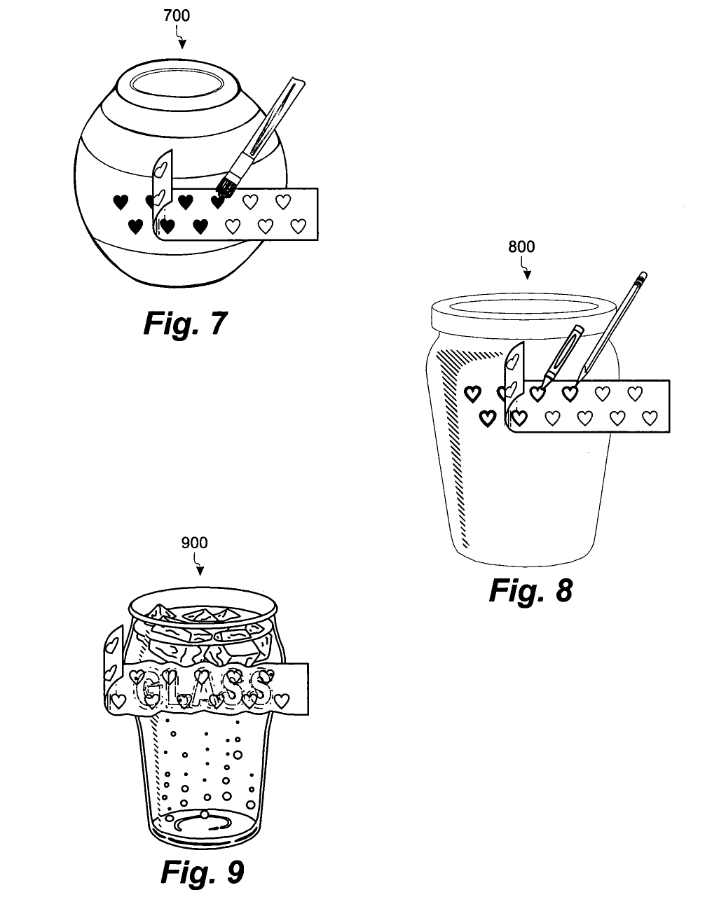

FIG. 7 shows at reference numeral 700 the application of a plurality of stencils using a segment of substrate roll 100 where the stencils are being applied using a paint brush.

FIG. 8 shows at reference numeral 800 the application of stencils by using a crayon and a pencil to outline stencils on a non-planar vase surface.

FIG. 9 shows the application of a stencil to drinkware at reference numeral 900 in FIG. 9, wherein a plurality of stencils are on a segment of substrate roll 100 and are being applied in a non-planar surface on the drinkware.

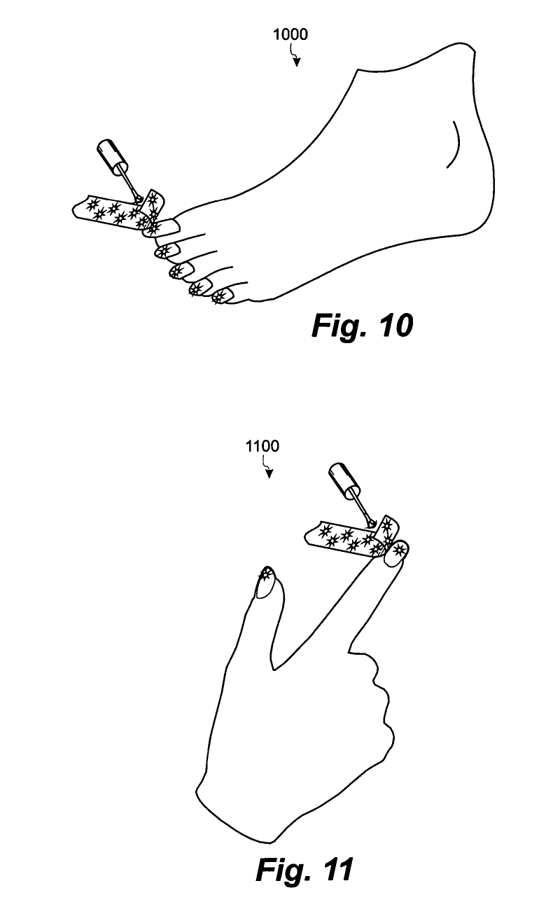

FIG. 10 shows at reference numeral 1000 the application of stencils using a toenail polish brush. Here, a portion of a segment of substrate roll 100 has a plurality of stencils thereon.

FIG. 11 shows at reference numeral 1100 the application of stencils on a segment of substrate roll 100, where the application is made by a fingernail brush to a fingernail. The depicted segment of substrate roll 100 is shown as a breakaway view of the segment.

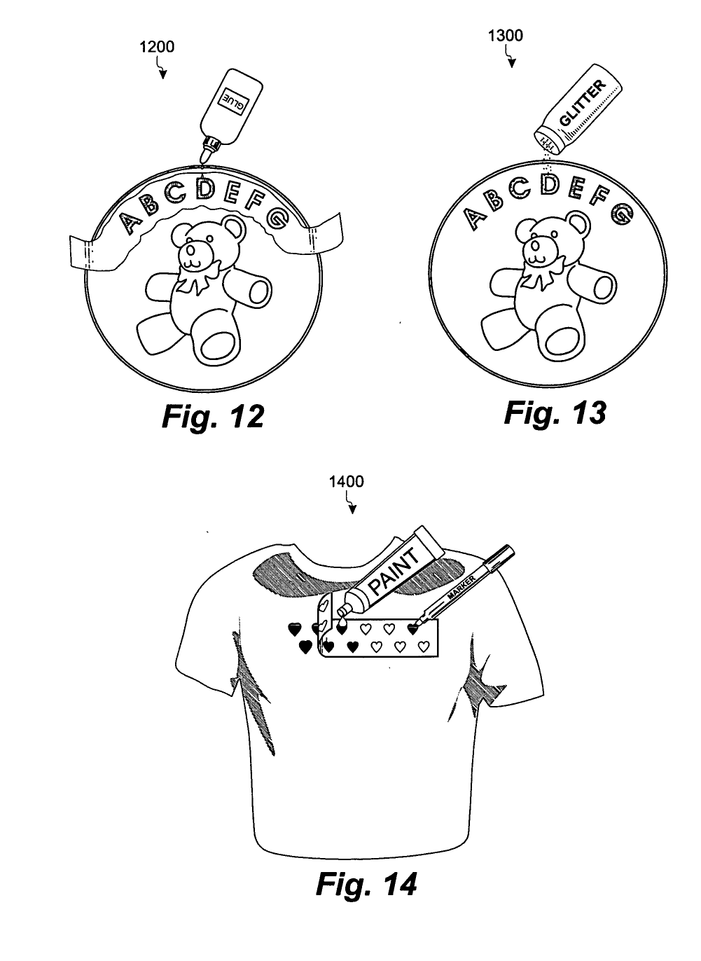

FIG. 12 and FIG. 13 shows, respectively at reference numerals 1200 and 1300, the first application of glue through stencils on a segment of a substrate roll 100 and then, after the segment has been removed from the depicted surface 1300, the application of glitter to the glue as was applied at reference numeral 1200. As can be seen from FIG. 12 at reference numeral 1200, a segment of substrate roll 100 has been shaped around the periphery of a circular surface so as to apply the glue within each stencil. As such, it is desirable that the substrate roll 100 be flexible so that it can be shaped around various surfaces.

FIG. 14 shows at reference numeral 1400 the application of paint in a liquid form and in a marker from though a pattern of stencils within a segment of substrate roll 100 so as to be applied to an article of clothing.

While preferred embodiments of this invention have been shown and described, modifications thereof can be made by one skilled in the art without departing from the spirit or teaching of this invention. The embodiments described herein are exemplary only and are not limiting. Many variations and modifications of the method and any apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims that follow, the scope of which shall include all equivalents of the subject matter of the claims.

1. A substrate comprising:
a plurality of segments each having one or more stencils; and
a frangible portion of the substrate between adjacent said segments for detaching the adjacent said segments one from the other when the frangible portion of the substrate is broken.

2. The substrate as defined in claim 1, wherein each frangible portion of the substrate is more easily broken than other portions thereof.

3. The substrate as defined in claim 1, wherein the plurality of segments are flexible for being rolled into a hollow tube.

4. The substrate as defined in claim 1, wherein:
one or more said segments each has a set of stencils;
the stencils in each said set are topically related shapes.

5. The substrate as defined in claim 1, wherein:
each said frangible portion extends across a width of the substrate; and
the substrate is broken into separated pieces when any said frangible portion is broken across the width of the substrate.

6. The substrate as defined in claim 1, wherein the frangible portion of the substrate comprises a perforation in the substrate.

7. The substrate as defined in claim 1, wherein the frangible portion of the substrate is about equidistant from the nearest stencil on adjacent said segments of the substrate.

8. The substrate as defined in claim 1, wherein the frangible portion of the substrate further comprises means for detaching and reattaching adjacent said segments of the substrate.

9-13. (canceled)

14. The substrate as defined in claim 8, wherein the means for detaching and reattaching comprises a sticky material on at least one of the adjacent said segments.

15. The substrate as defined in claim 8, wherein the means for detaching and reattaching further comprises means for detaching adjacent said segments of the substrates at a first orientation one to the other to be detached one from the other and then to be reattached one to the other at a second said orientation.

16. The substrate as defined in claim 15, wherein the first orientation is linear and the second orientation is normal.

17. The substrate as defined in claim 15, wherein:
in the first orientation the adjacent said segments form an acute angle; and
in the second orientation the adjacent said segments form a non-acute angle.

18. The substrate as defined in claim 1, wherein each said stencil is filled with a punch out portion.

19. The substrate as defined in claim 18, wherein the punch out portion is held within the stencil by one or more frangible materials, whereby each said punch out portion can be removed from within the stencil by pressure on the same without substantially deforming the stencil.

20. The substrate as defined in claim 19, wherein the punch out portion has sticky substance on one surface thereof.

21. The substrate as defined in claim 20, wherein the sticky substance is revealed by removal of a covering.

22-38. (canceled)

39. A substrate comprising:
a plurality of flexible segments each:
having one or more stencils therein;
being adjacent to and separated from another said flexible segment by a perforation in the substrate; and
being detached from the adjacent said flexible segment when the perforation in the substrate is broken.

40. The substrate as defined in claim 39, wherein:
each said perforation extends across a width of the substrate; and
the substrate is broken into sections that are separated one from the other when any said perforation is broken across the width of the substrate.

41. The substrate as defined in claim 39, wherein:
one or more said segments each have a set of stencils; and
the stencils in each said set are topically related shapes.

42. The substrate as defined in claim 41, wherein the topically related shapes are selected from the group consisting of:
letters of an alphabet;
symbols of a written language;
declinations of a noun;
conjugations of a verb;
male and female of a species;
progressively different ages of a species;
single digit numbers;
chemical symbols; and
mathematical symbols.

43. The substrate as defined in claim 39, wherein the perforated portion of the substrate is about equidistant from the nearest stencil on adjacent said segments of the substrate.

44. The substrate as defined in claim 39, wherein the perforated portion of the substrate further comprises means for detaching and reattaching adjacent said segments of the substrate.

45. The substrate as defined in claim 44, wherein the means for detaching and reattaching comprises a sticky material on at least one of the adjacent said segments.

46. The substrate as defined in claim 44, wherein the means for detaching and reattaching further comprises means for detaching adjacent said segments of the substrates at a first orientation one to the other to be detached one from the other and then to be reattached one to the other at a second said orientation.

47. The substrate as defined in claim 39, wherein each said stencil is filled with a punch out portion.

48. The substrate as defined in claim 47, wherein the punch out portion is held within the stencil by one or more frangible materials, whereby each said punch out portion can be removed from within the stencil by pressure on the same without substantially deforming the stencil.

49. The substrate as defined in claim 47, wherein the punch out portion has sticky substance on one surface thereof.

50. The substrate as defined in claim 49, wherein the sticky substance is revealed by removal of a covering.

51. A substrate comprising:
a plurality of segments each having one or more stencils therein; and
a plurality of frangible portions of the substrate each being:
situated between and attaching a respective pair of adjacent said segments one to the other; and
for detaching the adjacent said segments one from the other when broken.

52. The substrate as defined in claim 51, wherein each said frangible portion of the substrate is more easily broken than other portions thereof.

53. The substrate as defined in claim 51, wherein the breaking of any said frangible portion also breaks the substrate into separate parts.

54. The substrate as defined in claim 51, wherein the perforated portion of the substrate further comprises means for detaching and reattaching adjacent said segments of the substrate.

55. The substrate as defined in claim 54, wherein the means for detaching and reattaching comprises a sticky material on at least one of the adjacent said segments.

56. The substrate as defined in claim 54, wherein the means for detaching and reattaching further comprises means for detaching adjacent said segments of the substrates at a first orientation one to the other to be detached one from the other and then to be reattached one to the other at a second said orientation.

57. The substrate as defined in claim 51, wherein each said stencil is filled with a punch out portion.

58. The substrate as defined in claim 57, wherein the punch out portion is held within the stencil by one or more frangible materials, whereby each said punch out portion can be removed from within the stencil by pressure on the same without substantially deforming the stencil.

59. The substrate as defined in claim 57, wherein the punch out portion has sticky substance on one surface thereof.

60. The substrate as defined in claim 59, wherein the sticky substance is revealed by removal of a covering.

61. The substrate as defined in claim 51, wherein:
each said frangible portion extends across a width of the substrate; and the substrate is broken into separated pieces when any said frangible portion is broken across the width of the substrate.
